(19) United States
(12) Patent Application Publication
(10) Pub. No.: US 2026/0249215 A1
(43) Pub. Date: Aug. 27, 2026

(54) Screening Device, Screening Element and Method for Producing a Screening Device

(71) Applicant: HUBER SE, Berching (DE)

(72) Inventors: Reinhard STIEGLER, Berching (DE); Sven ROMANO, Berching (DE)

(21) Appl. No.: 19/544,468

(22) Filed: Feb. 19, 2026

(30) Foreign Application Priority Data
Feb. 21, 2025 (DE) 10 2025 106 661.2

(51) Int. Cl. B01D 29/44

(52) U.S. Cl. CPC B01D 29/445; B01D 2201/40

(57) ABSTRACT

In one aspect, a screening device for separating screenings from a flowing liquid contaminated with screenings, for example wastewater, includes a frame and a bar screen which is fixed to the frame, and has a plurality of screening elements.

### CROSS-REFERENCE TO RELATED APPLICATIONS

The present application is based upon and claims the right of priority to German Patent Application No. 10 2025 106 661.2, filed Feb. 21, 2025, the disclosure of which is hereby incorporated by reference herein in its entirety for all purposes.

### FIELD OF THE INVENTION

The present subject matter relates to a screening device for separating screenings from a flowing liquid contaminated with screenings, for example wastewater, with a frame and a bar screen which is fixed to the frame and has a plurality of screening elements. The present subject matter also relates to a screening element for a screening device and to a method for producing a screening device.

### BACKGROUND OF THE INVENTION

In general, screening devices are used, for example, to remove coarse debris, in particular from municipal wastewater. This debris can include, for example, objects, paper, and plant residue. The contaminated liquid is directed to a bar screen, which retains the coarse debris. The liquid that has been pre-treated in such a way can then be subjected, for example, to further treatment measures. The debris retained by the bar screen can be removed and separately disposed of by means of an appropriate mechanism. Such a device is disclosed, for example, in DE 10 2015 108 006 A1.

The bar screens of known screening devices typically consist of a plurality of screening elements, which as such must be correspondingly stably designed in order to remain undamaged by collisions with debris and must be stably connected to a frame of the screening devices in order not to become detached when collisions occur. The known screening elements are welded individually to the frame, which complicates the production of the bar screen. In addition, the welded joint makes maintenance of a possibly damaged bar screen considerably more difficult.

### SUMMARY OF THE INVENTION

In various aspects, the problem addressed by the present subject matter relates to improving known screening devices and screening elements and production methods for screening devices with respect to the aforementioned disadvantages.

The present subject matter is directed to a screening device, a screening element, and a method for producing a screening device having the features as described and claimed herein. Advantageous embodiments are the subject matter of one or more claims.

The screening device according to the present subject matter is suitable for separating screenings from a flowing liquid contaminated with screenings, for example wastewater. The screening device has a frame and a bar screen which is fixed to the frame and has a plurality of screening elements. According to the present subject matter, the bar screen and the screening elements are at least partially curved, in particular in an arcuate manner, and the screening elements have a plurality of inter-locking elements, by means of which they are fastened to the frame via a plurality of fastening devices of the screening device.

The curved design of the bar screen and of the screening elements according to the present subject matter makes it possible, for example, to collect the debris in a targeted manner in a certain region of the bar screen. In addition, the removal can be carried out, for example, by a mechanism running along the curvature. As a result, the cleaning performance of the screening device is increased and the likelihood of the bar screen becoming clogged is reduced. The screening elements can be, for example, flat, wherein a thickness of the screening elements is in particular substantially less than a height and width. During operation as intended, the surfaces of the screening elements extend in particular parallel to the liquid flow. This gives the screening elements high stability with respect to collisions with debris and avoids turbulence in the liquid flow. The curved course of the screening elements extends in particular parallel to the surface of the screening elements. A deflection of the liquid flow due to the curvature preferably does not occur. The curvature can have, for example, a constant radius or, for example, different radii of curvature in sections. In an arcuate curvature, the curvature preferably has a substantially constant radius of curvature.

Due to the use of inter-locking elements and fastening devices instead of welded joints, the installation of the screening elements is simplified. In particular, the screening elements are detachably connected to the fastening devices, such that maintenance and exchange of individual screening elements or groups of screening elements is made possible without the need to replace the entire bar screen. The screening elements, the fastening devices, and/or the frame are preferably made of stainless steel.

The inter-locking elements can be, for example, tabs, hooks, pegs, and/or guide rails which cooperate with correspondingly shaped receptacles in the fastening devices. The fastening devices are preferably at least partially fixedly connected, in particular welded, to the frame. In addition to an inter-locking connection between the screening elements and the fastening devices, a frictional connection, in particular due to clamping, is also conceivable.

The screening device can be designed in general to deflect the liquid flow, thereby making it possible, for example, to retain the debris in a more gentle manner. For example, the flow direction of the liquid flow can be deflected in the region of the screening device by an angle of substantially 90°. The screening elements are then oriented, for example, perpendicularly to the original liquid flow. To this end, the screening device can have, for example, a baffle plate for the liquid flow. It is conceivable that the first and/or the last screening element of the bar screen is reinforced, for example with a thickness that is increased in comparison to the other screening elements. As a result, these screening elements can resist load peaks that arise in these regions. In addition, it can be advantageous to close a gap between the bar screen and the frame using suitable means, such that debris is prevented from accumulating between the bar screen and the frame.

It is advantageous when the screening device has at least one cleaning rake, in particular a plurality of cleaning rakes, for removing the screenings, which cleaning rakes are movable along the bar screen in particular using at least one drive element. As a result, a continuous and automated removal of the retained debris from the surface of the bar screen is made possible. The curvature of the bar screen supports the transport process, since removal of the debris can be additionally supported by gravity. In particular, the cleaning rakes engage into the screening elements in order to also remove debris captured there.

The at least one drive element can be, for example, a conveyor chain or a roller chain having individual rollers which move, for example, along a guide of the screening device. The drive element is in particular an endless drive element which is guided, for example, over corresponding deflection devices, in particular deflection pulleys. The cleaning rakes are preferably fastened to the drive element. The drive element can be driven, for example, by an electric motor.

The movement of the cleaning rakes can be, for example, continuous or periodic, wherein the movement speed is adaptable in particular to the amount of accumulating debris. The cleaning rakes can be comb-like structures, the tines of which engage into the screening elements as described above. The spacing is selected in such a way that a reliable capture of the debris is ensured without mechanically loading the screening elements.

The screening device can have, for example, one or more scrapers, which discharge the captured debris at a defined position, for example at a discharge point of the screening device, into a collection container or onto a conveyor belt.

It is particularly advantageous when the screening elements have more than two, preferably at least four, inter-locking elements and the screening device has more than two fastening devices, preferably at least four fastening devices. The use of more than two inter-locking elements per screening element in connection with a corresponding number of fastening devices ensures a particularly stable and uniform fixation of the screening elements to the frame. Due to this multiple fastening arrangement, the mechanical loads arising during operation are uniformly distributed onto a plurality of fastening points. This prevents the screening elements from tilting or deforming even under a high screenings load or in a strong flow of the liquid to be cleaned. The inter-locking elements can be distributed, for example symmetrically, over the length of the screening element, whereby a balanced load distribution is achieved.

An embodiment having four or more fastening points additionally offers the advantage that individual fastening points can be released during maintenance work without the position of the screening element becoming lost, since the remaining fastening points ensure sufficient fixation. In particular, the screening elements can have six fastening devices and the screening device can have six fastening devices.

It is also advantageous when the fastening devices form support points for the screening elements on a side of the bar screen facing away from the liquid which is inflowing during operation of the screening device as intended. The arrangement of the fastening devices on the side of the bar screen facing away from the flow creates a defined support for the screening elements, whereby these are braced against the flow force of the liquid to be cleaned.

The arrangement of the fastening devices facing away from the flow also protects these against direct exposure to the screenings, whereby wear of the fastening devices is reduced. The accessibility of the fastening devices for maintenance and inspection work is also improved by this arrangement.

Furthermore, it is advantageous when the fastening devices have a preferably static receiving element and a preferably detachable clamping element. The cooperation between the static receiving element and the detachable clamping element allows for a fastening of the screening elements in a manner that is safe and, at the same time, low-maintenance. The static receiving element is used in particular as an invariable reference position for the exact orientation of the screening element, whereas the detachable clamping element effects the actual fixation.

The receiving element can in particular be shaped in such a way that it enables pre-positioning of the screening elements and thus simplifies installation. The receiving element and the clamping element can be designed, for example, to interlock with one another. The clamping element can in particular be a clamping plate. It is conceivable that a plurality of clamping elements is provided for each receiving element in order to allow for maintenance of the screening elements in groups.

The combination of a static receiving element and a releasable clamping element can also permit, for example, a certain relative motion between the screening element and the frame, for example, in order to compensate for thermal changes in length or to accommodate production tolerances. The clamping connection can be designed in such a way that it permits these motions within defined limits without the secure fixation being impaired.

It is particularly advantageous when the receiving element has at least one bore, in particular a threaded bore. The bore forms, for example, a standardized interface for receiving different types of fastening elements. A threaded bore makes it possible, for example, to adjust the clamping force in a precise and controlled manner by means of a corresponding threaded element. The receiving element can have a plurality of bores, which enables distribution of the clamping force or a redundant fastening of the clamping element.

It is also advantageous when the clamping element has at least one passage, in particular for a screw. The passage allows for a connection between the clamping element and the receiving element, for example, using any fastening elements. In particular, a screw connection between the clamping element and the receiving element forms a standardized and low-maintenance releasable connection. In addition, the clamping force can be adapted within certain limits by means of the torque applied during screwing in. The passage can be designed, for example, in such a way that the screw head of a screw sits flush. To this end, the passage has, for example, a bore, in particular a countersunk hole. The contact face around the passage can in particular be a planar or structured surface in order to optimally distribute the clamping force.

A plurality of passages can be provided in order to uniformly distribute the clamping force or to allow for redundant fastening. The combination of the passage and the screw enables controlled removal of the clamping element, wherein the screw can act as a guide and prevents the clamping element from unintentionally falling out. The passage can additionally be configured in such a way that it forms a rotation lock for the clamping element, for example, due to a shape that is not round or due to additional guide elements.

It is particularly advantageous when the receiving element has a comb structure. Due to the comb structure, for example, defined receiving structures for the inter-locking elements of the screening elements are created, which stabilize the screening elements in one direction. The comb structure also makes it possible to unambiguously position a plurality of screening elements lying adjacent to one another and ensures that these are precisely oriented with respect to one another. The comb structure can be formed by webs arranged in parallel, which delimit guide grooves or receiving pockets. The intermediate spaces in the comb structure are preferably dimensioned in such a way that they enable easy insertion of the inter-locking elements.

The comb structure can be an integral part of the receiving element or a separate, exchangeable component. The geometry of the comb structure is preferably selected in such a way that no regions form in which debris can accumulate.

It is also advantageous when the clamping element has a plurality of openings for the inter-locking elements. The openings make it possible to directly feed the inter-locking elements through and thus to inter-lockingly fix the screening elements. The openings in the clamping element preferably correspond to the comb structure of the receiving element and together form precise guidance for the inter-locking elements.

The openings can be through-holes, the shape and size of which are matched to the geometry of the inter-locking elements. The arrangement of the openings in the clamping element corresponds in particular to the position of the inter-locking elements and enables tension-free installation. The openings can be oversized in order to compensate for production tolerances and simplify installation.

The screening element according to the present subject matter is suitable for a screening device, in particular a screening device according to the preceding description, wherein the features described can be implemented individually or in any combination. According to the present subject matter, the screening element is distinguished by the fact that it is at least partially curved, in particular in an arcuate manner, and has a plurality of inter-locking elements for fastening to fastening devices of the screening device.

The curved, in particular arcuate, design of the screening element can contribute to efficient collection and to removal of the screenings, as described above. The plurality of inter-locking elements ensures a secure and, in particular, releasable connection to the fastening devices of the screening device without the need for welded joints.

The curvature can have a constant radius or a variable course of curvature. The screening element can preferably be made of a corrosion-resistant material, for example, of stainless steel.

The inter-locking elements can in particular be integral parts of the screening element. The inter-locking elements are arranged in such a way that they ensure a defined position of the screening element in the screening device.

It is also advantageous when the screening element has more than two, preferably at least four, inter-locking elements. By providing more than two inter-locking elements, a particularly stable and uniform fastening on the frame of the screening device is ensured. Due to the distribution of the forces arising during operation onto a plurality of fastening points, local stress peaks are avoided and the mechanical load on the screening element is reduced.

The inter-locking elements can be symmetrically distributed over the length of the screening element, wherein, for example, four or six inter-locking elements, depending on the length of the screening element, offer an optimal balance between stability and installation effort. The spacing between the inter-locking elements is preferably selected in such a way that a uniform load distribution is ensured. The inter-locking elements can be, for example, tabs, hooks, pegs, and/or guide rails.

The multiple fastening arrangement also enables precise orientation of the curved screening element, since the position is defined by a plurality of defined points. In maintenance work, the multiple fastening arrangement offers the advantage that individual fastening points can be released, whereas the remaining inter-locking elements continue to hold the screening element in position.

The method for producing a screening device according to the present subject matter, which screening device is designed in particular according to the preceding description, wherein the features described can be implemented individually or in any combination, has the method steps of providing a frame with a plurality of fastening devices, providing a plurality of at least partially, in particular arcuately, curved screening elements with a plurality of inter-locking elements each, inserting the plurality of screening elements into the fastening devices to produce a bar screen, and inter-lockingly fixing the inter-locking elements to the fastening devices.

The production method described enables efficient and precise assembly of the screening device without the need for welding work. Providing the frame with the plurality of fastening devices forms the foundation for the assembly. The fastening devices can have been already pre-adjusted in order to simplify the subsequent orientation of the screening elements.

The curved screening elements are produced and provided with the required inter-locking elements, for example, in a separate production process. The screening elements are punched or cut, for example, from metal sheets, wherein a laser or a water jet can be used for cutting. In particular, the screening elements can be composed of a plurality of individual parts, for example, by means of welding, which reduces the size of the necessary punch presses or cutting machines.

The screening elements are preferably inserted sequentially, wherein each screening element is initially loosely inserted into the corresponding fastening devices. The fastening devices can be configured in such a way that they enable pre-positioning of the screening elements. The screening elements can be fixed, for example and as described above, by clamping. This can be carried out, for example, by tightening clamping screws or actuating quick clamping mechanisms.

It is particularly advantageous when the fixation of the inter-locking elements to the fastening devices includes fixing a clamping element of the fastening devices to a receiving element of the fastening devices. The fixation of the screening elements by means of a clamping element and a receiving element enables controlled and precise installation combined with high operational reliability.

The receiving element initially forms a defined receiving position for the screening element, wherein the inter-locking elements are inserted in particular into the provided receiving pockets or guide grooves. The position of the screening element is predetermined, for example, by the geometry of the receiving element. The receiving element can preferably be configured in such a way that it enables pre-centering of the screen element.

The clamping element is then positioned in particular in such a way that it receives the inter-locking elements of the screening element in corresponding openings. The clamping force can be steplessly adjusted by means of suitable connecting elements, for example screws. The fixation can in particular be carried out in such a way that initially a loose pre-positioning is possible before the final clamping force is applied.

It is also advantageous when providing the frame with the fastening devices includes welding or screwing the frame together with the fastening devices. The permanent connection between the frame and the fastening devices by means of welding or screwing provides a stable foundation for the subsequent installation of the screening elements. The welded joint ensures that the fastening devices are integrated into the frame structure in a lasting and load-bearing manner. A screw connection forms a releasable connection, which possibly simplifies subsequent maintenance and repairs of the screening device. The fastening devices can contribute to the stabilization of the frame.

The welded joints can be continuous or interrupted seams or spot welds, wherein the type of welded joint is preferably adapted to the anticipated operating loads. After the welding process, mechanical reworking of the fastening devices can be carried out in order to ensure the required dimensional accuracy for the subsequent installation of the screening elements. The welded connection points can be provided with corrosion protection, which ensures the long-term stability of the connection. The welded joint between the frame and the fastening devices forms a part of the supporting structure of the screening device and transfers the forces arising during operation into the frame.

### BRIEF DESCRIPTION OF THE FIGURES

Further advantages of the present subject matter are described in the following exemplary embodiments, wherein:

FIG. 1 shows a first exemplary embodiment of a screening device according to the present subject matter in a schematic front view,

FIG. 2 shows a first exemplary embodiment of a screening element according to the present subject matter,

FIG. 3 shows a second exemplary embodiment of the screening element according to the present subject matter,

FIG. 4 shows a frame of a second exemplary embodiment of the screening device according to the present subject matter,

FIG. 5 shows a fastening device of the screening device according to the present subject matter, and

FIG. 6 shows a connection region of screening elements and the fastening device in a partially cutaway isometric view.

### DETAILED DESCRIPTION

In the following description of the figures, the same reference characters are used for identical and/or at least comparable features in the various figures. The individual features, their embodiment and/or mode of operation are usually explained in detail only in the first mention thereof. If individual features are not explained in detail once again, their embodiment and/or mode of operation corresponds to the embodiment and the mode of operation of the features having the same effect or the same name that have already been described.

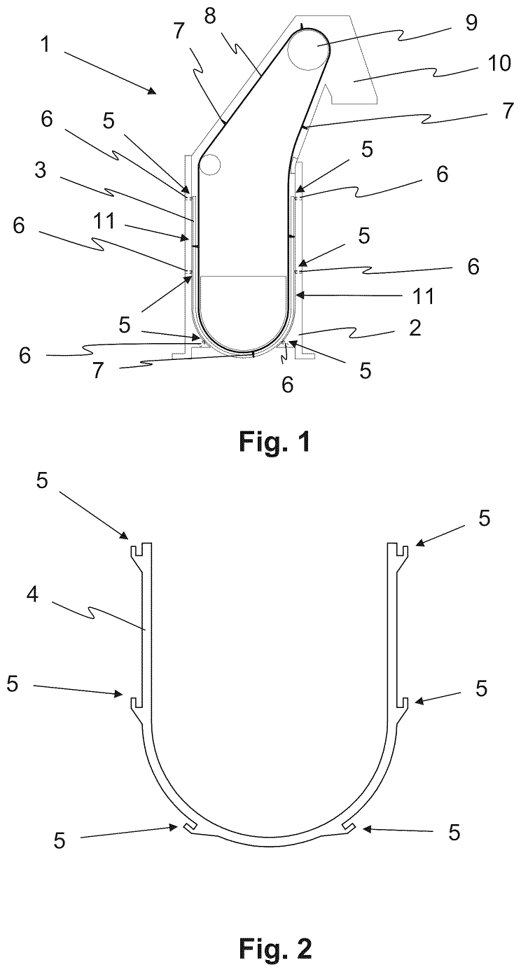

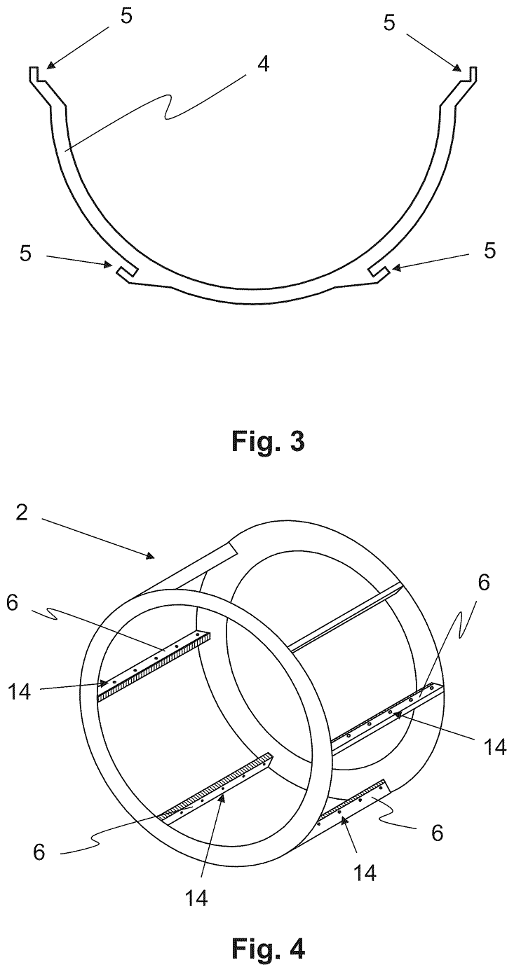

FIG. 1 shows the screening device 1 for separating screenings from a flowing liquid contaminated with screenings, for example wastewater, in a schematic front view. The screening device 1 has a frame 2 to which an arcuate bar screen 3 is fixed. The bar screen 3 consists of a plurality of screening elements 4 (see in particular FIGS. 2 and 3) which are flat, wherein a thickness of the screening elements 4 is substantially less than their height and width.

The screening elements 4 are provided with a plurality of inter-locking elements 5, which are fastened to the frame 2 via corresponding fastening devices 6. The inter-locking elements 5 are symmetrically arranged on both sides 11 of the curved bar screen 3, whereby a balanced load distribution is achieved. The use of inter-locking elements 5 and fastening devices 6 instead of welded joints enables simplified assembly and improved maintenance as well as a simple exchange of screening elements 4 or groups of screening elements 4.

The represented screening device 1 deflects the liquid flow which, in this arrangement shown in FIG. 1, would come from the direction ahead of the image plane, substantially by 90°, wherein the liquid flow is then conducted through both sides of the bar screen 3. The surfaces of the screening elements 4 are oriented correspondingly parallel to the liquid flow there, which gives the screening elements 4 high stability with respect to collisions with debris.

A plurality of cleaning rakes 7, which are movable along the bar screen 3 using a drive element 8, are provided for the continuous cleaning of the bar screen 3. The drive element 8 is an endless drive element 8 and is guided over at least one deflection pulley 9. The drive element 8 can be driven, for example, by a motor (not represented), which is connected to the deflection pulley in the upper region of the screening device 1. The cleaning rakes 7 are, for example, comb-like structures, the tines of which engage into the screening elements 4 in order to remove screenings captured there as well.

The arcuate design of the bar screen 3 enables targeted collection of the debris in the lower region of the screening device 1 and supports the removal by the cleaning rakes 7, wherein the curvature additionally supports the transport process due to gravity. The captured screenings are transported to a discharge point 10, where they can be discharged, for example, into a collection container (not represented).

The fastening devices 6 are arranged on a side 11 of the bar screen 3 facing away from the liquid which is inflowing during operation of the screening device 1 as intended, as support points for the screening elements 4. This arrangement of the fastening devices 6 facing away from the flow protects these against direct exposure to the screenings, whereby wear of the fastening devices 6 is reduced and accessibility for maintenance and repair work is improved.

The multiple arrangement of the inter-locking elements 5 with the corresponding fastening devices 6 ensures a particularly stable and uniform fixation of the screening elements 4 to the frame 2. Due to this multiple fastening arrangement, the mechanical loads arising during operation are uniformly distributed onto a plurality of fastening points, which prevents the screening elements 4 from tilting or deforming even under a high screenings load or in a strong flow of the liquid to be cleaned.

FIG. 2 shows a first exemplary embodiment of a screening element 4 according to the present subject matter. A plurality of these screening elements 4 form, for example, the bar screen 3 of the screening device 1 from FIG. 1. The screening element 4 is U-shaped with a partially arcuate curvature, wherein the curvature has a substantially constant radius. The screening element 4 is flat, wherein a thickness of the screening element 4 is substantially less than its height and width.

A plurality of inter-locking elements 5 are symmetrically arranged on the screening element 4, which are used for the detachable fastening to the fastening devices 6 of the screening device 1. The inter-locking elements 5 are integral parts of the screening element 4 and are arranged in such a way that they ensure a defined position of the screening element 4 in the screening device 1.

In the exemplary embodiment shown, the screening element 4 has six inter-locking elements 5, which are arranged in pairs on both sides of the screening element 4. This multiple fastening arrangement ensures a particularly stable and uniform fastening to the frame 2 of the screening device 1. Due to the distribution of the forces arising during operation onto six fastening points, local stress peaks are avoided and the mechanical load on the screening element 4 is reduced.

The inter-locking elements 5 are hook-shaped structures which cooperate with receptacles, for example correspondingly shaped receptacles, in the fastening devices 6. This design enables fastening in a manner that is safe and, at the same time, low-maintenance without the need for welded joints.

The curved course of the screening element 4 extends parallel to its surface and, when the screening element is installed, supports the targeted collection and the removal of screenings. The screening element 4 is preferably made of a corrosion-resistant material, for example of stainless steel, in order to meet the demands under continuous operation with contaminated liquid.

FIG. 3 shows an alternative exemplary embodiment of the screening element 4 according to the present subject matter. The screening element 4 is exclusively arcuately curved here, wherein the curvature also has a substantially constant radius here.

In contrast to the first exemplary embodiment, this screening element 4 has four inter-locking elements 5, which are arranged in pairs on the lateral regions of the curved screening element 4. The inter-locking elements 5 are symmetrically distributed over the length of the screening element 4, whereby a balanced load distribution is achieved.

In this exemplary embodiment, the inter-locking elements 5 are integral parts of the screening element 4 and have a hook-shaped structure. The screening element 4 is flat in this exemplary embodiment, wherein the thickness of the screening element 4 is substantially less than its height and width.

FIG. 4 shows a frame 2 of a second exemplary embodiment of the screening device 1 in a perspective representation. The frame 2 has an annular basic structure on which a plurality of fastening devices 6 are arranged. The frame 2 is used, for example, to accommodate a plurality of screening elements 4 from the exemplary embodiment from FIG. 3.

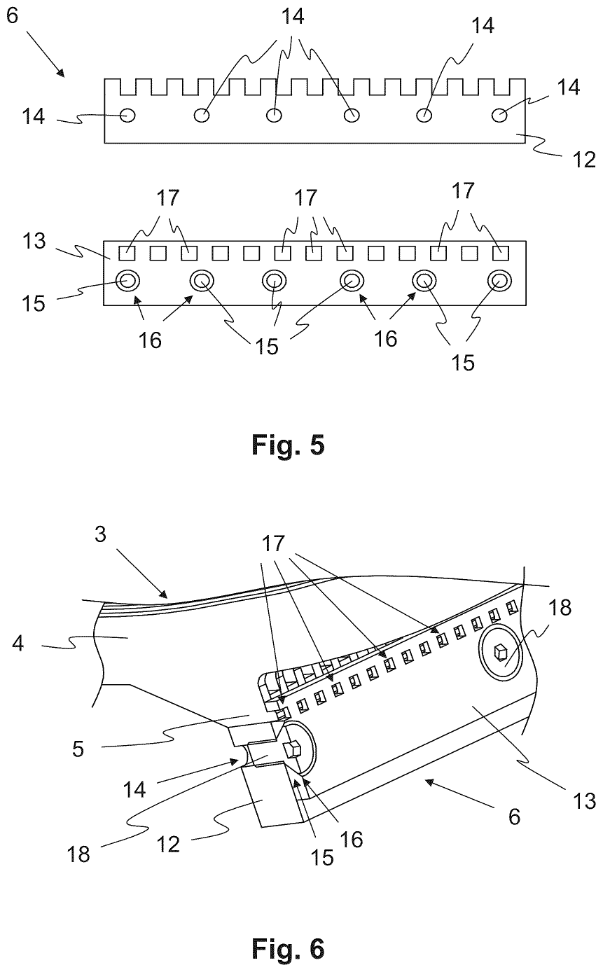

The fastening devices 6 are distributed over a lower region of the periphery of the frame 2 and each have bores 14, which are, for example, threaded bores. The threaded bores form standardized interfaces for receiving different types of fastening elements. In a two-part design of the fastening devices 6 (see FIG. 5), the represented elements are, for example, the receiving elements 12 for the screening elements 4.

The fastening devices 6 are fixedly connected, in particular welded, to the frame 2, whereby a stable foundation for the subsequent installation of the screening elements 4 is provided. Due to the permanent connection between the frame 2 and the fastening devices 6 by means of the welded joint, a lasting and load-bearing integration of the fastening devices 6 into the frame structure is ensured. The annular design of the frame 2 corresponds to the arcuate design of the screening elements 4 and thus supports the efficient collection and the removal of the screenings during operation. The fastening devices 6 are arranged in such a way that they enable a precise orientation of the screening elements 4 and, at the same time, are easily accessible for maintenance and inspection work.

FIG. 5 shows a detailed representation of a fastening device 6 of the screening device 1. The fastening device 6 has a receiving element 12 and a clamping element 13 in this example, which together enable a fastening of the screening elements 4 in a manner that is safe and low-maintenance. The receiving element 12 has, for example, a comb structure, which laterally fixes the screening elements 4 and enables exact positioning of the screening elements 4 during the assembly of the screening device 1.

The clamping element 13 is provided with a plurality of openings 17, which enables direct insertion of the inter-locking elements 5 and thus ensures an inter-locking fixation of the screening elements 4. In order to connect the clamping element 13 to the receiving element 12, a plurality of passages 15 are provided with countersunk holes 16. These passages 15 are designed in such a way that a screw head of a screw sits flush.

Due to this design, a releasable connection between the screening elements 4 and the fastening devices 6 is made possible, which permits simple maintenance and an exchange of individual screening elements 4 or groups of screening elements 4 without the need to replace the entire bar screen.

FIG. 6 shows a partially cutaway isometric view of a connection region between the bar screen 3 having a plurality of screening elements 4 and a fastening device 6. The screening elements 4 each have inter-locking elements 5, which are connected to the fastening device 6.

The fastening device 6 has a receiving element 12 and a clamping element 13, which together form an inter-locking and releasable connection with the screening elements 4. The inter-locking elements 5 are inserted into the openings 17 in the clamping element 13. The receiving element 12 has bores 14, whereas the clamping element 13 is provided with corresponding openings 17 for feeding screws 18 through. The connection between the receiving element 12 and the clamping element 13 is established using screws 18, the heads of which sit flush in the countersunk holes 16 in the clamping element 13. The screening elements 4 are fixed by the comb structure of the receiving element 12, the inter-locking connection between the inter-locking elements 5 and the openings 17 in the clamping element 13, and the screw connection between the receiving element 12 and the clamping element 13.

### List of Reference Characters

1 screening device
2 frame
3 bar screen
4 screening element
5 inter-locking element
6 fastening device
7 cleaning rake
8 drive element
9 deflection pulley
10 discharge point
11 side
12 receiving element
13 clamping element
14 bore
15 passage
16 countersunk hole
17 opening
18 screw

1-14. (canceled)

15. A screening device for separating screenings from a flowing liquid contaminated with screenings, the screening device comprising:
a frame, and
a bar screen which is fixed to the frame and has a plurality of screening elements,
wherein the bar screen and the plurality of screening elements are at least partially curved, and the plurality of screening elements have a plurality of inter-locking elements configured to fasten the plurality of screening elements to the frame via a plurality of fastening devices of the screening device.

16. The screening device of claim 15, further comprising at least one cleaning rake, for removing the screenings, wherein the at least one cleaning rake is configured to be movable along the bar screen.

17. The screening device of claim 15, wherein the plurality of inter-locking elements includes more than two inter-locking elements and the plurality of fastening devices includes more than two fastening devices.

18. The screening device of claim 15, wherein the plurality of fastening devices are configured to form support points for the plurality of screening elements on a side of the bar screen facing away from the flowing liquid.

19. The screening device of claim 15, wherein each of the plurality of fastening devices includes a receiving element and a clamping element.

20. The screening device of claim 19, wherein the receiving element includes at least one bore.

21. The screening device of claim 19, wherein the clamping element includes at least one passage.

22. The screening device of claim 19, wherein the receiving element has a comb structure.

23. The screening device of claim 19, wherein the clamping element includes a plurality of openings for the plurality of inter-locking elements.

24. A screening element for a screening device, wherein the screening element is at least partially curved, and includes a plurality of inter-locking elements configured to fasten to a plurality of fastening devices of the screening device.

25. The screening element of claim 24, wherein the plurality of inter-locking elements includes more than two inter-locking elements.

26. A method for producing a screening device, comprising:
providing a frame with a plurality of fastening devices,
providing each of a plurality of at least partially, curved screening elements with a plurality of inter-locking elements,
inserting the plurality of screening elements into the plurality of fastening devices to produce a bar screen, and
inter-lockingly fixing the plurality of inter-locking elements to the plurality of fastening devices.

27. The method of claim 26, wherein inter-lockingly fixing the plurality of inter-locking elements to the plurality of fastening devices includes fixing a clamping element of the plurality of fastening devices to a receiving element of the plurality of fastening devices.

28. The method of claim 26, wherein providing the frame with the plurality of fastening devices includes welding and/or screwing the frame to the plurality of fastening devices.
